(19) United States
(12) Patent Application Publication
(10) Pub. No.: US 2023/0319637 A1
(43) Pub. Date: Oct. 5, 2023

(54) DUAL AUDIO CHANNELS OVER DUAL QUALITY OF SERVICE FLOWS

(71) Applicant: QUALCOMM Incorporated, San Diego, CA (US)

(72) Inventors: Nan ZHANG, Beijing (CN); Zhiguo LI, Beijing (CN); Yongjun XU, Beijing (CN)

(21) Appl. No.: 18/041,754

(22) PCT Filed: Oct. 6, 2020
(86) PCT No.: PCT/CN2020/119825

§ 371 Date: Feb. 15, 2023

(51) Int. Cl. H04W 28/08; H04W 28/10

(52) U.S. Cl. CPC H04W 28/0967; H04W 28/10; H04W 76/15

(57) ABSTRACT

Various aspects of the present disclosure generally relate to wireless communication. In some aspects, a user equipment (UE) may receive an indication that dual audio channels are to be established over dual quality of service (QoS) flows. The UE may establish a first audio channel of the dual audio channels over a first QoS flow and a second audio channel of the dual audio channels over a second QoS flow based at least in part on receiving the indication. Numerous other aspects are provided.

### FIELD OF THE DISCLOSURE

Aspects of the present disclosure generally relate to wireless communication and to techniques and apparatuses for dual audio over dual quality of service flows.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving an indication that dual audio channels are to be established over dual quality of service (QoS) flows, and establishing a first audio channel of the dual audio channels over a first QoS flow and a second audio channel of the dual audio channels over a second QoS flow based at least in part on receiving the indication.

In some aspects, a method of wireless communication performed by a base station includes transmitting, to a UE, an indication that dual audio channels are to be established over dual QoS flows, and establishing a first audio channel of the dual audio channels over a first QoS flow for the UE and a second audio channel of the dual audio channels over a second QoS flow for the UE.

In some aspects, a method of wireless communication performed by a network entity includes determining that dual audio channels are to be established over dual QoS flows for a UE, and transmitting, to a base station, an instruction to establish a first audio channel of the dual audio channels over a first QoS flow for the UE and a second audio channel of the dual audio channels over a second QoS flow for the UE.

In some aspects, a UE for wireless communication includes memory and one or more processors coupled to the memory. For example, the one or more processors may be operatively, electronically, communicatively, or otherwise coupled to the memory. The memory includes instructions executable by the one or more processors to cause the UE to receive an indication that dual audio channels are to be established over dual QoS flows, and establish a first audio channel of the dual audio channels over a first QoS flow and a second audio channel of the dual audio channels over a second QoS flow based at least in part on receiving the indication.

In some aspects, a base station for wireless communication includes memory and one or more processors coupled to the memory, the memory including instructions executable by the one or more processors to cause the base station to transmit, to a UE, an indication that dual audio channels are to be established over dual QoS flows, and establish a first audio channel of the dual audio channels over a first QoS flow for the UE and a second audio channel of the dual audio channels over a second QoS flow for the UE.

In some aspects, a network entity for wireless communication includes memory and one or more processors coupled to the memory, the memory including instructions executable by the one or more processors to cause the network entity to determine that dual audio channels are to be established over dual QoS flows for a UE, and transmit, to a base station, an instruction to establish a first audio channel of the dual audio channels over a first QoS flow for the UE and a second audio channel of the dual audio channels over a second QoS flow for the UE.

In some aspects, a non-transitory computer-readable medium stores one or more instructions for wireless communication, the one or more instructions, when executed by one or more processors of a UE, cause the UE to receive an indication that dual audio channels are to be established over dual QoS flows, and establish a first audio channel of the dual audio channels over a first QoS flow and a second audio channel of the dual audio channels over a second QoS flow based at least in part on receiving the indication.

In some aspects, a non-transitory computer-readable medium stores one or more instructions for wireless communication, the one or more instructions, when executed by one or more processors of a base station, cause the base station to transmit, to a UE, an indication that dual audio channels are to be established over dual QoS flows, and establish a first audio channel of the dual audio channels over a first QoS flow for the UE and a second audio channel of the dual audio channels over a second QoS flow for the UE.

In some aspects, a non-transitory computer-readable medium stores one or more instructions for wireless communication, the one or more instructions, when executed by one or more processors of a network entity, cause the network entity to determine that dual audio channels are to be established over dual QoS flows for a UE, and transmit, to a base station, an instruction to establish a first audio channel of the dual audio channels over a first QoS flow for the UE and a second audio channel of the dual audio channels over a second QoS flow for the UE.

In some aspects, an apparatus for wireless communication includes means for receiving an indication that dual audio channels are to be established over dual QoS flows, and means for establishing a first audio channel of the dual audio channels over a first QoS flow and a second audio channel of the dual audio channels over a second QoS flow based at least in part on receiving the indication.

In some aspects, an apparatus for wireless communication includes means for transmitting, to a UE, an indication that dual audio channels are to be established over dual QoS flows, and means for establishing a first audio channel of the dual audio channels over a first QoS flow for the UE and a second audio channel of the dual audio channels over a second QoS flow for the UE.

In some aspects, an apparatus for wireless communication includes means for determining that dual audio channels are to be established over dual QoS flows for a UE, and means for transmitting, to a base station, an instruction to establish a first audio channel of the dual audio channels over a first QoS flow for the UE and a second audio channel of the dual audio channels over a second QoS flow for the UE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a user equipment (UE) in a wireless network, in accordance with various aspects of the present disclosure.

FIG. 3 is a diagram illustrating an example of dual connectivity, in accordance with various aspects of the present disclosure.

FIG. 4 is a diagram illustrating examples of carrier aggregation, in accordance with various aspects of the present disclosure.

FIG. 5 is a diagram illustrating an example of dual mono audio on a quality of service (QoS) flow, in accordance with various aspects of the present disclosure.

FIG. 6 is a diagram illustrating an example of dual audio channels on dual QoS flows, in accordance with various aspects of the present disclosure.

FIG. 7 is a diagram illustrating an example process performed, for example, by a UE, in accordance with various aspects of the present disclosure.

FIG. 8 is a diagram illustrating an example process performed, for example, by a base station, in accordance with various aspects of the present disclosure.

FIG. 9 is a diagram illustrating an example process performed, for example, by a network entity, in accordance with various aspects of the present disclosure.

FIGS. 10-12 are block diagrams of example apparatuses for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

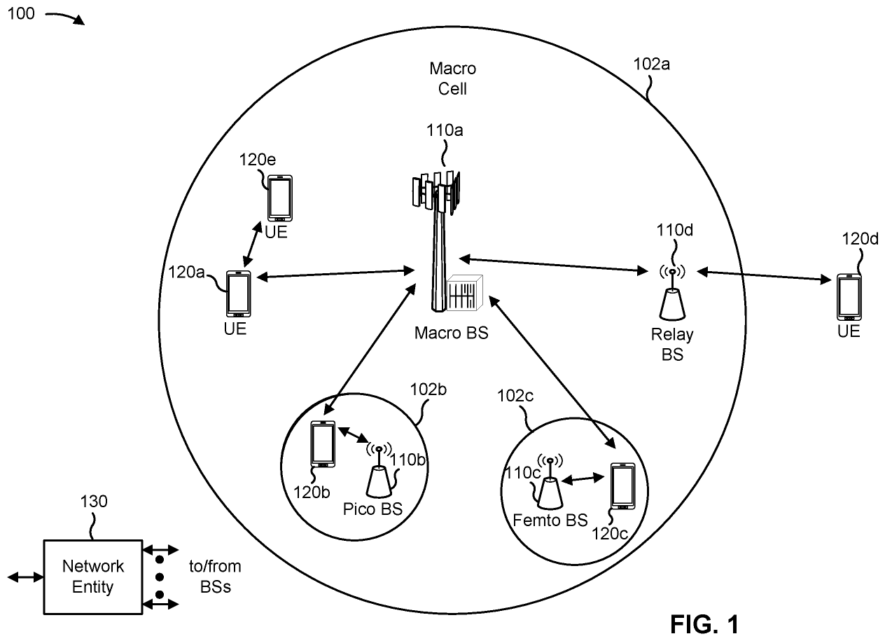

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a , a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 100a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network entity 130 in a core network (e.g., user plane function (UPF) of a 5GC) may couple to a set of BSs and may provide coordination and control for these BSs. Network entity 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband interne of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

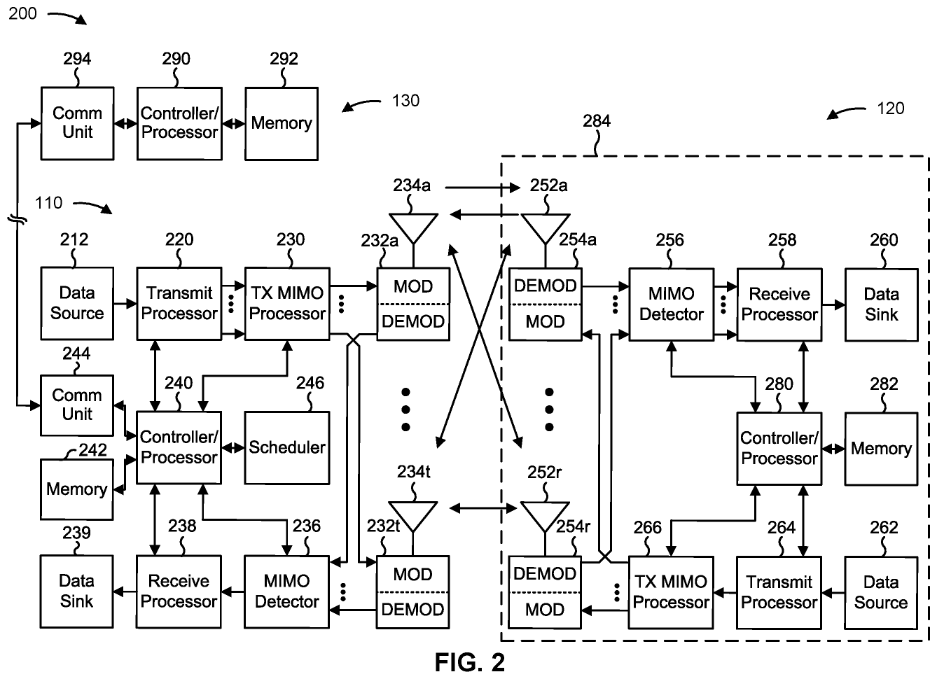

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network entity 130 may include communication unit 294, controller/processor 290, and memory 292. Network entity 130 may include, for example, one or more devices in a core network. Network entity 130 may communicate with base station 110 via communication unit 294.

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 1-12.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network entity 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 1-12.

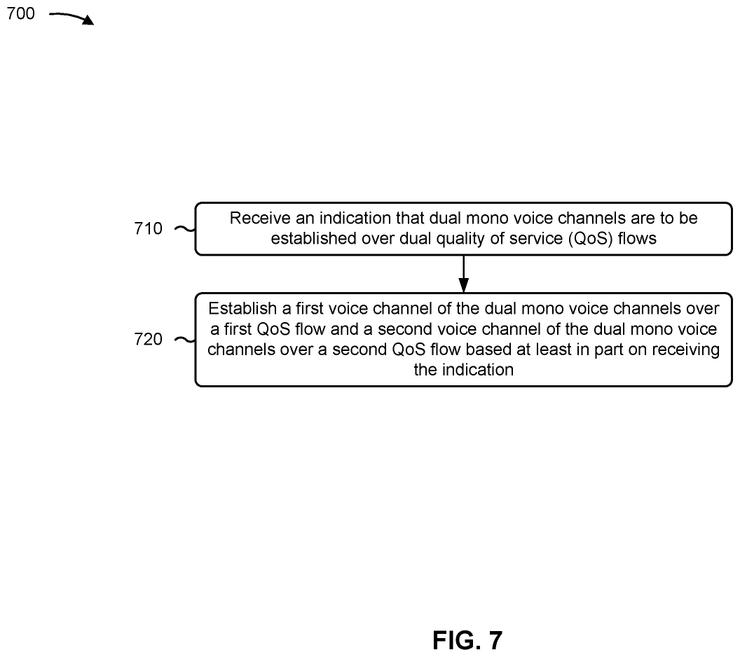

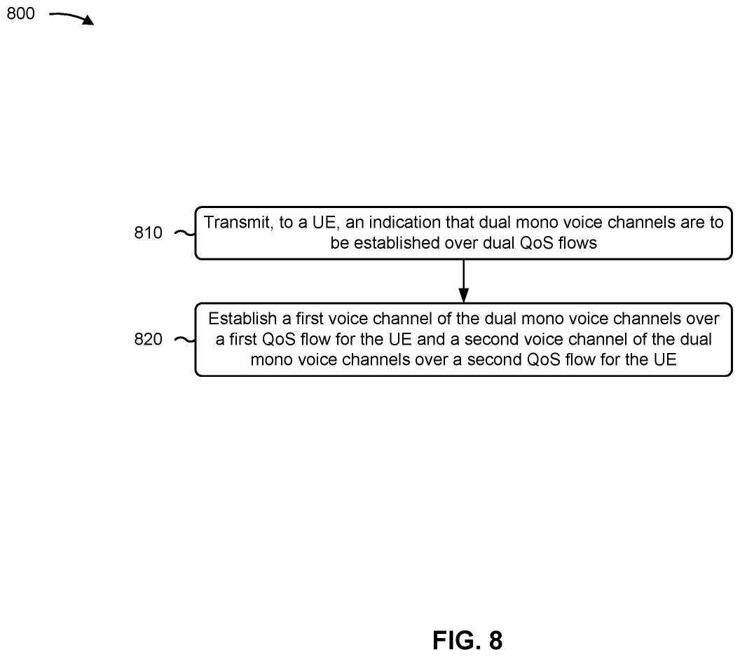

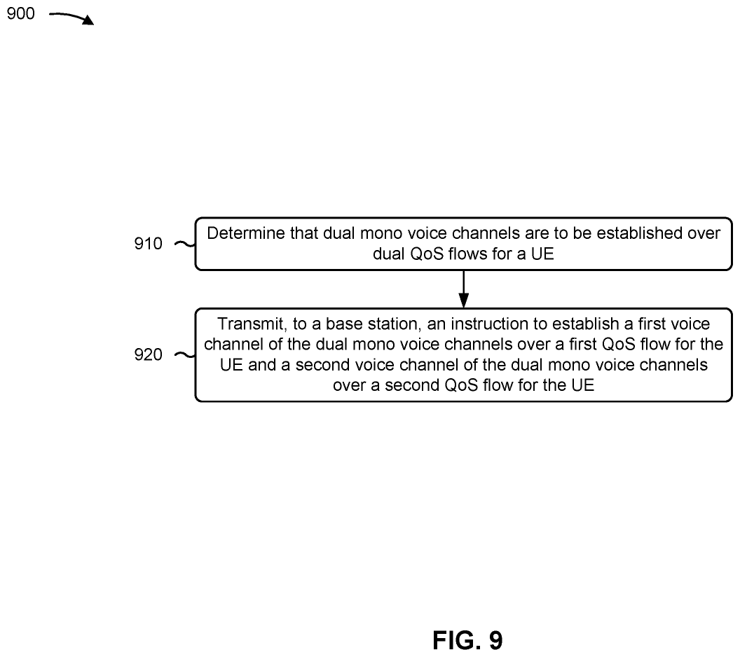

Controller/processor 240 of base station 110, controller/processor 280 of UE 120, controller/processor 290 of network entity 130, and/or any other component(s) of FIG. 2 may perform one or more techniques associated with dual audio over dual quality of service (QoS) flows, as described in more detail elsewhere herein. For example, controller/processor 240 of base station 110, controller/processor 280 of UE 120, controller/processor 290 of network entity 130, and/or any other component(s) of FIG. 2 may perform or direct operations of, for example, process 700 of FIG. 7, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 700 of FIG. 7, process 800 of FIG. 8, process 900 of FIG. 9, and/or other processes as described herein. In some aspects, executing instructions may include running the instructions, converting the instructions, compiling the instructions, interpreting the instructions, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

In some aspects, a UE 120 includes means for receiving an indication that dual audio channels are to be established over dual QoS flows, and/or means for establishing a first audio channel of the dual audio channels over a first QoS flow and a second audio channel of the dual audio channels over a second QoS flow based at least in part on receiving the indication. The means for UE 120 to perform operations described herein may include, for example, antenna 252, demodulator 254, MIMO detector 256, receive processor 258, transmit processor 264, TX MIMO processor 266, modulator 254, controller/processor 280, and/or memory 282.

In some aspects, a UE 120 includes means for maintaining one of: the first audio channel on the first QoS flow, or the second audio channel on the second QoS flow, based at least in part on determining that the other one of the first audio channel or the second audio channel has degraded or dropped.

In some aspects, a base station 110 includes means for transmitting, to a UE, an indication that dual audio channels are to be established over dual QoS flows, and/or means for establishing a first audio channel of the dual audio channels over a first QoS flow for the UE and a second audio channel of the dual audio channels over a second QoS flow for the UE. The means for base station 110 to perform operations described herein may include, for example, transmit processor 220, TX MIMO processor 230, modulator 232, antenna 234, demodulator 232, MIMO detector 236, receive processor 238, controller/processor 240, memory 242, and/or scheduler 246.

In some aspects, a base station 110 includes means for assigning the first QoS flow to a master node of a primary cell and the second QoS flow to a secondary node of a primary secondary cell or secondary cell.

In some aspects, a base station 110 includes means for scheduling the first QoS flow with a first 5G QoS identifier (5QI) and the second QoS flow with a second 5QI.

In some aspects, a base station 110 includes means for maintaining one of: the first audio channel on the first QoS flow, or the second audio channel on the second QoS flow, based at least in part on determining that the other one of the first audio channel or the second audio channel has degraded or dropped.

In some aspects, a network entity 130 includes means for determining that dual audio channels are to be established over dual QoS flows for a UE, and/or means for transmitting, to a base station, an instruction to establish a first audio channel of the dual audio channels over a first QoS flow for the UE and a second audio channel of the dual audio channels over a second QoS flow for the UE. The means for network entity 130 to perform operations described herein may include, for example, controller/processor 290, memory 292, and/or communication unit 294.

As indicated above, FIG. 2 is provided as an example. Other examples may differ from what is described with regard to FIG. 2.

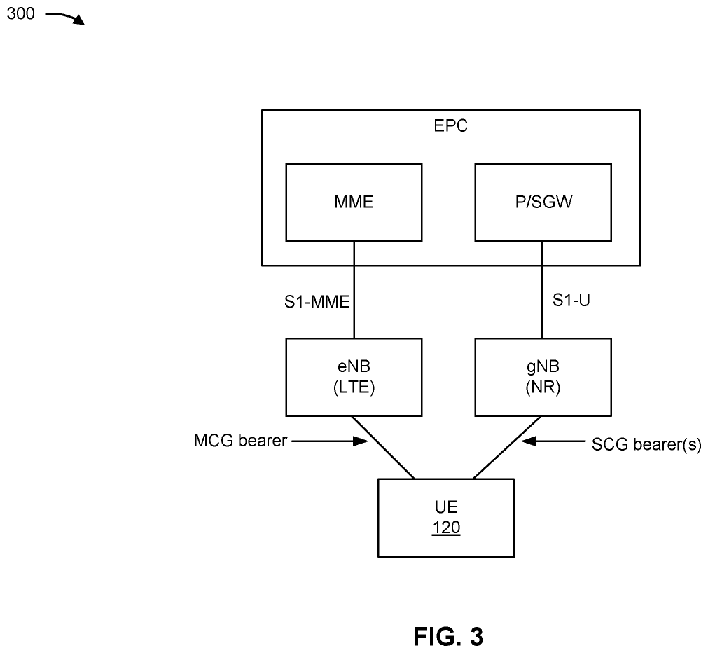

FIG. 3 is a diagram illustrating an example 300 of dual connectivity, in accordance with various aspects of the present disclosure. The example shown in FIG. 3 is for an Evolved Universal Mobile Telecommunications System Terrestrial Radio Access (E-UTRA)-NR dual connectivity (ENDC) mode. In the ENDC mode, a UE 120 communicates using an LTE RAT on a master cell group (MCG), and the UE 120 communicates using an NR RAT on a secondary cell group (SCG). However, aspects described herein may apply to an ENDC mode (e.g., where the MCG is associated with an LTE RAT and the SCG is associated with an NR RAT), an NR-E-UTRA dual connectivity (NEDC) mode (e.g., where the MCG is associated with an NR RAT and the SCG is associated with an LTE RAT), an NR dual connectivity (NRDC) mode (e.g., where the MCG is associated with an NR RAT and the SCG is also associated with the NR RAT), or another dual connectivity mode (e.g., (e.g., where the MCG is associated with a first RAT and the SCG is associated with one of the first RAT or a second RAT). The ENDC mode is sometimes referred to as an NR or 5G non-standalone (NSA) mode. Thus, as used herein, a dual connectivity mode may refer to an ENDC mode, a NEDC mode, an NRDC mode, and/or another type of dual connectivity mode.

As shown in FIG. 3, a UE 120 may communicate with both an eNB (e.g., a 4G base station 110) and a gNB (e.g., a 5G base station 110), and the eNB and the gNB may communicate (e.g., directly or indirectly) with a 4G/LTE core network, shown as an evolved packet core (EPC) that includes a mobility management entity (MME), a packet data network gateway (PGW), a serving gateway (SGW), and/or the like. In FIG. 3, the PGW and the SGW are shown collectively as P/SGW. In some aspects, the eNB and the gNB may be co-located at the same base station 110. In some aspects, the eNB and the gNB may be included in different base stations 110 (e.g., may not be co-located).

As further shown in FIG. 3, in some aspects, a wireless network that permits operation in a 5G NSA mode may permit such operations using a master cell group (MCG) for a first RAT (e.g., an LTE RAT, a 4G RAT, and/or the like) and an SCG for a second RAT (e.g., an NR RAT, a 5G RAT, and/or the like). In this case, the UE 120 may communicate with the eNB via the MCG, and may communicate with the gNB via the SCG. In some aspects, the MCG may anchor a network connection between the UE 120 and the 4G/LTE core network (e.g., for mobility, coverage, control plane information, and/or the like), and the SCG may be added as additional carriers to increase throughput (e.g., for data traffic, user plane information, and/or the like). In some aspects, the gNB and the eNB may not transfer user plane information between one another. In some aspects, a UE 120 operating in a dual connectivity mode may be concurrently connected with an LTE base station 110 (e.g., an eNB) and an NR base station 110 (e.g., a gNB) (e.g., in the case of ENDC or NEDC), or may be concurrently connected with one or more base stations 110 that use the same RAT (e.g., in the case of NRDC). In some aspects, the MCG may be associated with a first frequency band (e.g., a sub-6 GHz band and/or an FR1 band) and the SCG may be associated with a second frequency band (e.g., a millimeter wave band and/or an FR2 band).

The UE 120 may communicate via the MCG and the SCG using one or more radio bearers (e.g., data radio bearers (DRBs), signaling radio bearers (SRBs), and/or the like). For example, the UE 120 may transmit or receive data via the MCG and/or the SCG using one or more DRBs. Similarly, the UE 120 may transmit or receive control information (e.g., radio resource control (RRC) information, measurement reports, and/or the like) using one or more SRBs. In some aspects, a radio bearer may be dedicated to a specific cell group (e.g., a radio bearer may be an MCG bearer, an SCG bearer, and/or the like). In some aspects, a radio bearer may be a split radio bearer. A split radio bearer may be split in the uplink and/or in the downlink. For example, a DRB may be split on the downlink (e.g., the UE 120 may receive downlink information for the MCG or the SCG in the DRB) but not on the uplink (e.g., the uplink may be non-split with a primary path to the MCG or the SCG, such that the UE 120 transmits in the uplink only on the primary path). In some aspects, a DRB may be split on the uplink with a primary path to the MCG or the SCG. A DRB that is split in the uplink may transmit data using the primary path until a size of an uplink transmit buffer satisfies an uplink data split threshold. If the uplink transmit buffer satisfies the uplink data split threshold, the UE 120 may transmit data to the MCG or the SCG using the DRB.

As indicated above, FIG. 3 is provided as an example. Other examples may differ from what is described with respect to FIG. 3.

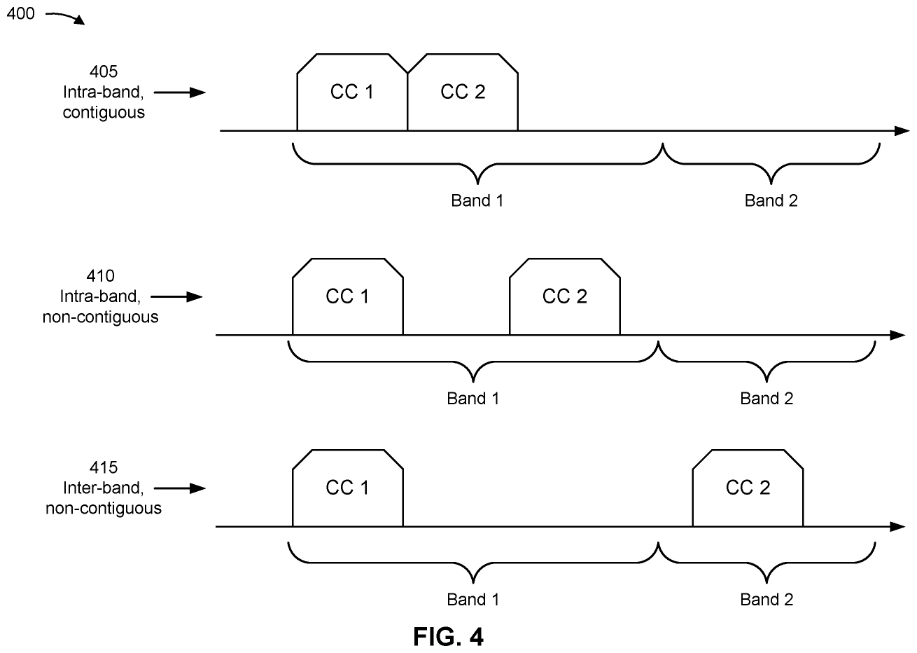

FIG. 4 is a diagram illustrating examples 400 of carrier aggregation, in accordance with various aspects of the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A base station 110 may configure carrier aggregation for a UE 120, such as in a radio resource control (RRC) message, downlink control information (DCI), and/or the like.

As shown by reference number 405, in some aspects, carrier aggregation may be configured in an intra-band contiguous mode where the aggregated carriers are contiguous to one another and are in the same band. As shown by reference number 410, in some aspects, carrier aggregation may be configured in an intra-band non-contiguous mode where the aggregated carriers are non-contiguous to one another and are in the same band. As shown by reference number 415, in some aspects, carrier aggregation may be configured in an inter-band non-contiguous mode where the aggregated carriers are non-contiguous to one another and are in different bands.

In carrier aggregation, a UE 120 may be configured with a primary carrier and one or more secondary carriers. In some aspects, the primary carrier may carry control information (e.g., downlink control information, scheduling information, and/or the like) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

As indicated above, FIG. 4 is provided as an example. Other examples may differ from what is described with regard to FIG. 4.

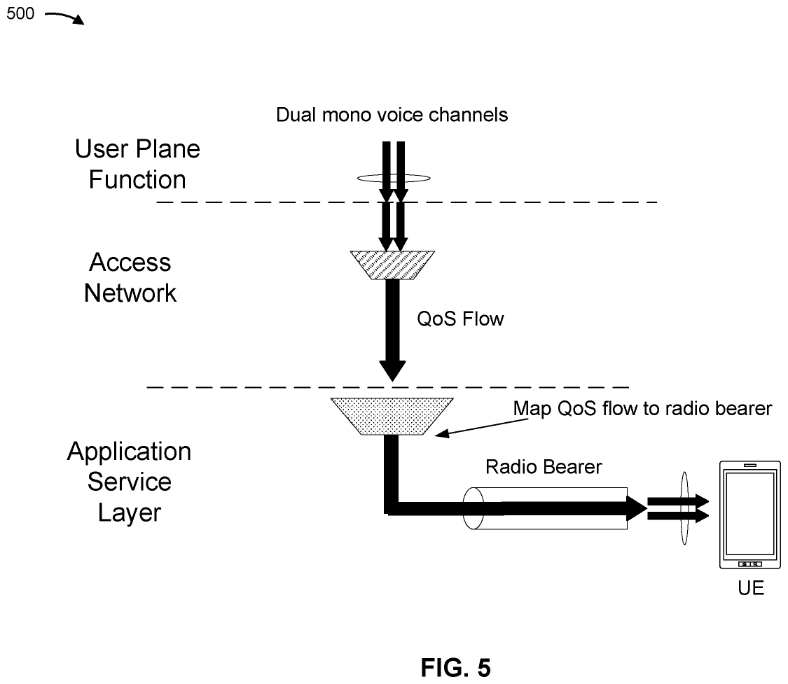

FIG. 5 is a diagram illustrating an example 500 of dual mono audio on a QoS flow, in accordance with various aspects of the present disclosure.

Mono or monophonic audio involves sounds that are mixed together into a single mono channel. To prevent a listener from hearing only one channel (e.g., out of only one side of a headphone), a network may duplicate the single mono channel onto a second channel. This is referred to as “dual mono audio.” Dual audio channels may also carry dual stereo channels over NR, which may be referred to as “voice over NR,” or “VOLAR.”

QoS in 5G is flow based. Packets are classified and marked using a QFI (QoS flow identifier). The QoS flows are mapped in the access network to DRBs. Example 500 shows dual audio channels (e.g., dual mono voice channels) that are carried from a network entity, such as a UPF in a core network (e.g., 5GC), through an access network (e.g., gNB). The dual mono voice channels are carried in a single QoS flow. In an application service layer, the network may map the QoS flow to a radio bearer, which carries the dual mono voice channels to a UE. The UE may receive a full 20 milliseconds of audio samples before starting to decode the audio samples. However, if there is a problem with the QoS flow, both voice channels are dropped (e.g., dual mono audio or VOLAR service is broken), and the UE does not receive any audio from the voice channels. This leads to a bad user experience, and the UE may waste time, power, processing resources, and signaling resources as the UE tries to recover the voice channels.

As indicated above, FIG. 5 is provided as an example. Other examples may differ from what is described with regard to FIG. 5.

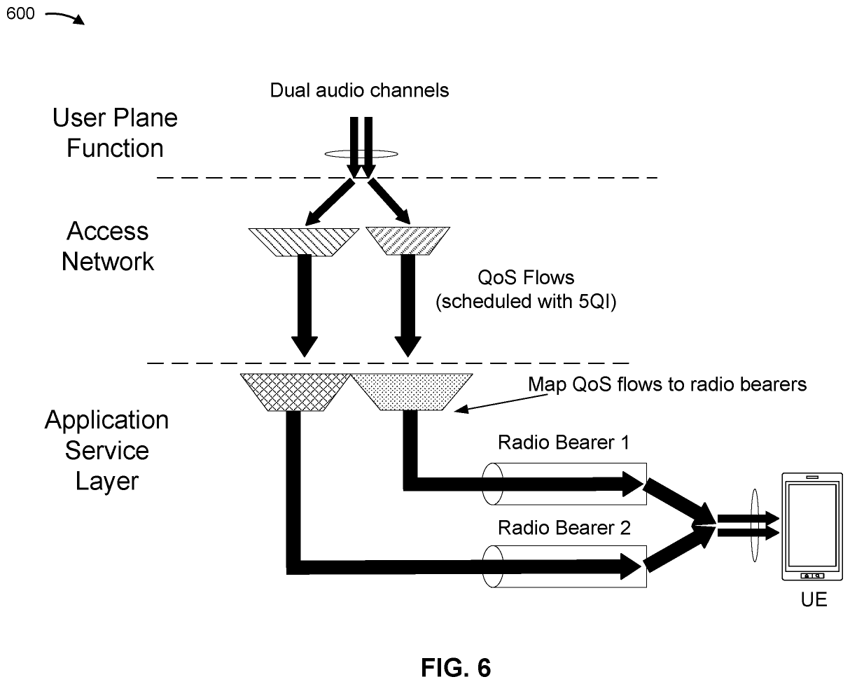

FIG. 6 is a diagram illustrating an example 600 of dual audio channels on dual QoS flows, in accordance with various aspects of the present disclosure.

According to various aspects described herein, a network may establish dual audio channels to a UE on separate QoS flows, or dual QoS flows.

If one channel on one QoS flow is dropped, the UE may still receive the other channel of the dual audio channels on the other QoS flow. Separate audio channels on independent QoS flows improve reliability, because the UE may receive or transmit audio clearly if one channel fails but the remaining channel is of sufficient quality. Dual audio channels on dual QoS flows provide for better audio quality, and provide an improved technique for NR applications, such as for VOLAR.

In some aspects, the UE may operate in dual connectivity or carrier aggregation. While dual mono voice channels may not depend on each other for decoding, a UE in radio access network multi-radio dual connectivity cannot distinguish dual voice channels packets in a single QoS flow. This may increase an end to end latency of voice packets if packets are dropped.

In some aspects, an NR access network, such as a next generation RAN (NG-RAN), may schedule dual QoS flows. For example, the access network may schedule a QoS flow A for voice channel A and a QoS flow B for voice channel B in NR-NR DC. The UE may assign QoS flow A to a master node (primary cell) and QoS flow B to a secondary node (primary secondary cell or secondary cell). Dual cells of the access network may schedule QoS flows A and B according to respective 5QIs and other QoS flow parameters. Therefore, the UE may decode a voice channel on one QoS flow even if the other voice channel on the other QoS flow is dropped. As a result, audio reliability (e.g., VONR reliability) increases without wasting processing and signaling resources. Extra latency is avoided, as the UE does not need to wait for other audio packets.

As indicated above, FIG. 6 is provided as an example. Other examples may differ from what is described with regard to FIG. 6.

FIG. 7 is a diagram illustrating an example process 700 performed, for example, by a UE, in accordance with various aspects of the present disclosure. Example process 700 is an example where the UE (e.g., a UE 120 depicted in FIGS. 1-3, the UE depicted in FIGS. 5 and 6) performs operations associated with dual audio over dual QoS flows.

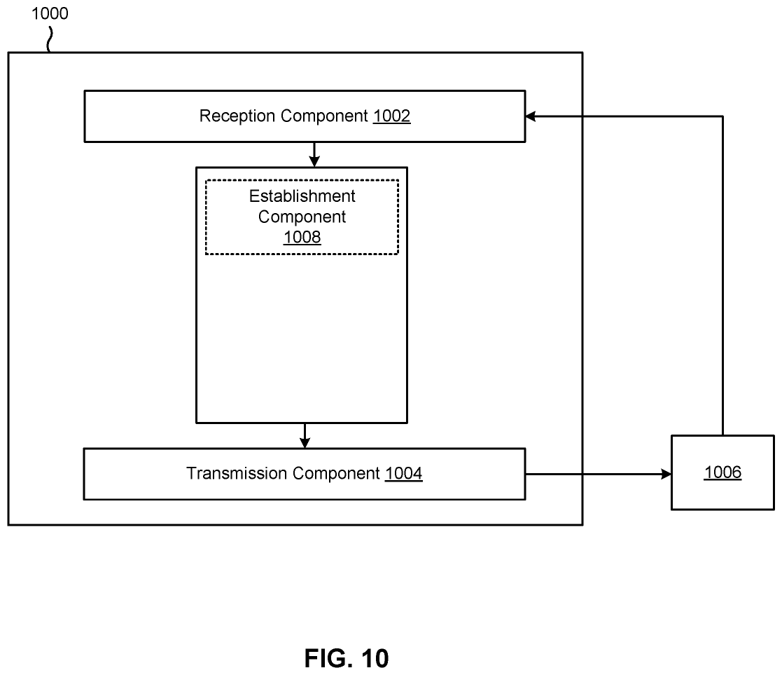

As shown in FIG. 7, in some aspects, process 700 may include receiving an indication that dual audio channels are to be established over dual QoS flows (block 710). For example, the UE (e.g., using reception component 1002 depicted in FIG. 10) may receive an indication that dual audio channels are to be established over dual QoS flows, as described above.

As further shown in FIG. 7, in some aspects, process 700 may include establishing a first audio channel of the dual audio channels over a first QoS flow and a second audio channel of the dual audio channels over a second QoS flow based at least in part on receiving the indication (block 720). For example, the UE (e.g., using establishment component 1008 depicted in FIG. 10) may establish a first audio channel of the dual audio channels over a first QoS flow and a second audio channel of the dual audio channels over a second QoS flow based at least in part on receiving the indication, as described above.

Process 700 may include additional aspects, such as any single aspect or any combination of aspects described below and/or in connection with one or more other processes described elsewhere herein.

In a first aspect, the first QoS flow and the second QoS flow are associated with dual connectivity for the UE.

In a second aspect, alone or in combination with the first aspect, the first QoS flow and the second QoS flow are associated with carrier aggregation for the UE.

In a third aspect, alone or in combination with one or more of the first and second aspects, process 700 includes maintaining one of the first audio channel on the first QoS flow, or the second audio channel on the second QoS flow, based at least in part on determining that the other one of the first audio channel or the second audio channel has degraded or dropped.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with various aspects of the present disclosure. Example process 800 is an example where the base station (e.g., a base station 110 depicted FIGS. 1-2, the eNB or gNB depicted in FIG. 3, the access network shown in FIGS. 5 and 6) performs operations associated with dual audio over dual QoS flows.

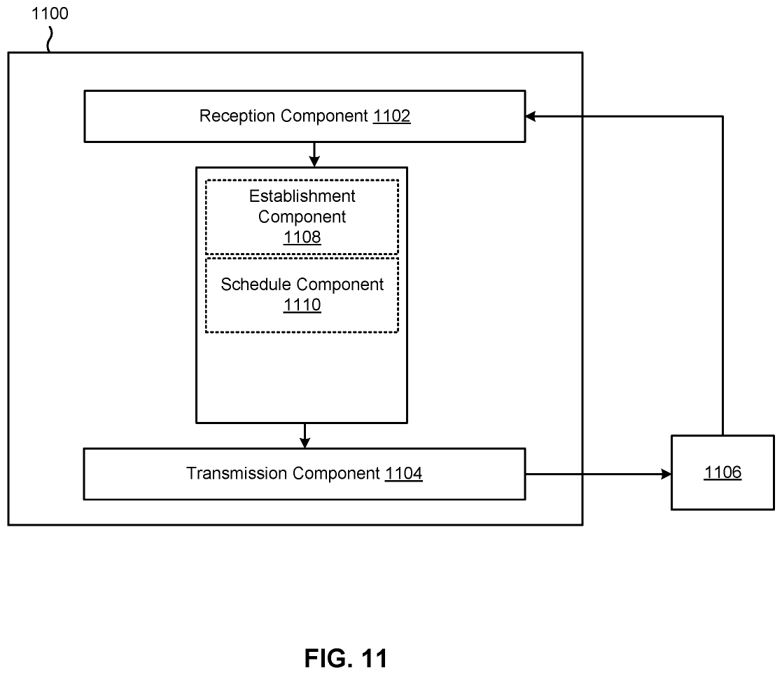

As shown in FIG. 8, in some aspects, process 800 may include transmitting, to a UE, an indication that dual audio channels are to be established over dual QoS flows (block 810). For example, the base station (e.g., using transmission component 1104 depicted in FIG. 11) may transmit, to a UE, an indication that dual audio channels are to be established over dual QoS flows, as described above.

As further shown in FIG. 8, in some aspects, process 800 may include establishing a first audio channel of the dual audio channels over a first QoS flow for the UE and a second audio channel of the dual audio channels over a second QoS flow for the UE (block 820). For example, the base station (e.g., using establishment component 1108 depicted in FIG. 11) may establish a first audio channel of the dual audio channels over a first QoS flow for the UE and a second audio channel of the dual audio channels over a second QoS flow for the UE, as described above.

Process 800 may include additional aspects, such as any single aspect or any combination of aspects described below and/or in connection with one or more other processes described elsewhere herein.

In a first aspect, the first QoS flow and the second QoS flow are associated with dual connectivity for the UE.

In a second aspect, alone or in combination with the first aspect, process 800 includes assigning the first QoS flow to a master node of a primary cell (PCell) and the second QoS flow to a secondary node of a primary secondary cell (PSCell) or secondary cell (SCell).

In a third aspect, alone or in combination with one or more of the first and second aspects, the first QoS flow and the second QoS flow are associated with carrier aggregation for the UE.

In a fourth aspect, alone or in combination with one or more of the first through third aspects, process 800 includes scheduling the first QoS flow with a first 5QI and the second QoS flow with a second 5QI.

In a fifth aspect, alone or in combination with one or more of the first through fourth aspects, process 800 includes maintaining one of the first audio channel on the first QoS flow, or the second audio channel on the second QoS flow, based at least in part on determining that the other one of the first audio channel or the second audio channel has degraded or dropped.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with various aspects of the present disclosure. Example process 900 is an example where the network entity (e.g., a network entity 130 depicted in FIGS. 1 and 2, the EPC depicted in FIG. 3, the UPF depicted in FIGS. 5 and 6) performs operations associated with dual audio over dual QoS flows.

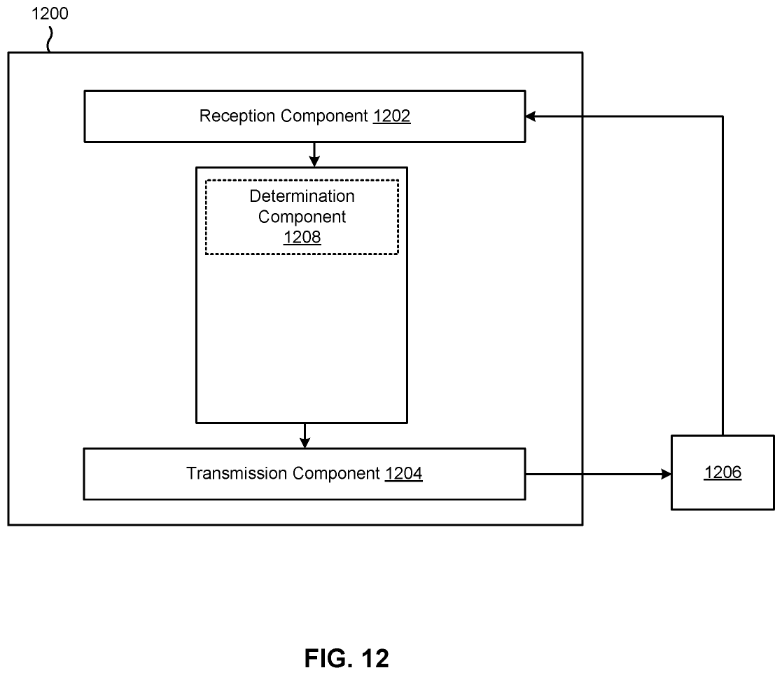

As shown in FIG. 9, in some aspects, process 900 may include determining that dual audio channels are to be established over dual QoS flows for a UE (block 910). For example, the network entity (e.g., using determination component 1208 depicted in FIG. 12) may determine that dual audio channels are to be established over dual QoS flows for a UE, as described above.

As further shown in FIG. 9, in some aspects, process 900 may include transmitting, to a base station, an instruction to establish a first audio channel of the dual audio channels over a first QoS flow for the UE and a second audio channel of the dual audio channels over a second QoS flow for the UE (block 920). For example, the network entity (e.g., using transmission component 1204 depicted in FIG. 12) may transmit, to a base station, an instruction to establish a first audio channel of the dual audio channels over a first QoS flow for the UE and a second audio channel of the dual audio channels over a second QoS flow for the UE, as described above.

Process 900 may include additional aspects, such as any single aspect or any combination of aspects described below and/or in connection with one or more other processes described elsewhere herein.

In a first aspect, the first QoS flow and the second QoS flow are associated with dual connectivity for the UE.

In a second aspect, alone or in combination with the first aspect, the first QoS flow and the second QoS flow are associated with carrier aggregation for the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include an establishment component 1008, among other examples.

In some aspects, the apparatus 1000 may be configured to perform one or more operations described herein in connection with FIGS. 1-6. Additionally, or alternatively, the apparatus 1000 may be configured to perform one or more processes described herein, such as process 700 of FIG. 7. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, memory, or a combination thereof, of the UE described above in connection with FIG. 2. In some aspects, the transmission component 1004 may be co-located with the reception component 1002 in a transceiver.

The reception component 1002 may receive an indication that dual audio channels are to be established over dual QoS flows. The establishment component 1008 may establish a first audio channel of the dual audio channels over a first QoS flow and a second audio channel of the dual audio channels over a second QoS flow based at least in part on receiving the indication. In some aspects, the establishment component 1008 may include one or more antennas, a demodulator, a MIMO detector, a receive processor, a modulator, a transmit MIMO processor, a transmit processor, a controller/processor, memory, or a combination thereof, of the UE described above in connection with FIG. 2.

The establishment component 1008 may maintain one of: the first audio channel on the first QoS flow, or the second audio channel on the second QoS flow, based at least in part on determining that the other one of the first audio channel or the second audio channel has degraded or dropped.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a block diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include an establishment component 1108 and/or a schedule component 1110, among other examples.

In some aspects, the apparatus 1100 may be configured to perform one or more operations described herein in connection with FIGS. 1-6. Additionally, or alternatively, the apparatus 1100 may be configured to perform one or more processes described herein, such as process 800 of FIG. 8. In some aspects, the apparatus 1100 and/or one or more components shown in FIG. 11 may include one or more components of the base station described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, memory, or a combination thereof, of the base station described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, memory, or a combination thereof, of the base station described above in connection with FIG. 2. In some aspects, the transmission component 1104 may be co-located with the reception component 1102 in a transceiver.

The transmission component 1104 may transmit, to a UE, an indication that dual audio channels are to be established over dual QoS flows. The establishment component 1108 may establish a first audio channel of the dual audio channels over a first QoS flow for the UE and a second audio channel of the dual audio channels over a second QoS flow for the UE. In some aspects, the establishment component 1108 may include one or more antennas, a demodulator, a MIMO detector, a receive processor, a modulator, a transmit MIMO processor, a transmit processor, a controller/processor, memory, or a combination thereof, of the base station described above in connection with FIG. 2.

The schedule component 1110 may assign the first QoS flow to a master node of a PCell and the second QoS flow to a secondary node of a PSCell or SCell. The schedule component 1110 may schedule the first QoS flow with a first 5QI and the second QoS flow with a second 5QI. In some aspects, the schedule component 1110 may include a demodulator, a MIMO detector, a receive processor, a modulator, a transmit MIMO processor, a transmit processor, a controller/processor, memory, or a combination thereof, of the base station described above in connection with FIG. 2.

The establishment component 1108 may maintain one of: the first audio channel on the first QoS flow, or the second audio channel on the second QoS flow, based at least in part on determining that the other one of the first audio channel or the second audio channel has degraded or dropped.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a block diagram of an example apparatus 1200 for wireless communication. The apparatus 1200 may be a network entity, or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a determination component 1208, among other examples.

In some aspects, the apparatus 1200 may be configured to perform one or more operations described herein in connection with FIGS. 1-6. Additionally, or alternatively, the apparatus 1200 may be configured to perform one or more processes described herein, such as process 900 of FIG. 9. In some aspects, the apparatus 1200 and/or one or more components shown in FIG. 12 may include one or more components of the network entity described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, memory, or a combination thereof, of the network entity described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, memory, or a combination thereof, of the network entity described above in connection with FIG. 2. In some aspects, the transmission component 1204 may be co-located with the reception component 1202 in a transceiver.

The determination component 1208 may determine that dual audio channels are to be established over dual QoS flows for a UE. In some aspects, the determination component 1208 may include a controller/processor, memory, or a combination thereof, of the network entity described above in connection with FIG. 2. The transmission component 1204 may transmit, to a base station, an instruction to establish a first audio channel of the dual audio channels over a first QoS flow for the UE and a second audio channel of the dual audio channels over a second QoS flow for the UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, software, and/or a combination of hardware and software. As used herein, a processor is implemented in hardware, software, and/or a combination of hardware and software. Software is to be construed broadly to mean instructions, instruction sets, code, code segments, program code, programs, subprograms, software modules, applications, software applications, software packages, routines, subroutines, objects, executables, threads of execution, procedures, functions, and/or the like, whether referred to as software, firmware, middleware, microcode, hardware description language, or otherwise.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, software, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification.

Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving an indication that dual audio channels are to be established over dual quality of service (QoS) flows; and
establishing a first audio channel of the dual audio channels over a first QoS flow and a second audio channel of the dual audio channels over a second QoS flow based at least in part on receiving the indication.

2. The method of claim 1, wherein the first QoS flow and the second QoS flow are associated with dual connectivity for the UE.

3. The method of claim 1, wherein the first QoS flow and the second QoS flow are associated with carrier aggregation for the UE.

4. The method of claim 1, further comprising maintaining one of: the first audio channel on the first QoS flow, or the second audio channel on the second QoS flow, based at least in part on determining that the other one of the first audio channel or the second audio channel has degraded or dropped.

5. A method of wireless communication performed by a base station, comprising:
transmitting, to a user equipment (UE), an indication that dual audio channels are to be established over dual quality of service (QoS) flows; and
establishing a first audio channel of the dual audio channels over a first QoS flow for the UE and a second audio channel of the dual audio channels over a second QoS flow for the UE.

6. The method of claim 5, wherein the first QoS flow and the second QoS flow are associated with dual connectivity for the UE.

7. The method of claim 6, further comprising assigning the first QoS flow to a master node of a primary cell and the second QoS flow to a secondary node of a primary secondary cell or secondary cell.

8. The method of claim 5, wherein the first QoS flow and the second QoS flow are associated with carrier aggregation for the UE.

9. The method of claim 5, further comprising scheduling the first QoS flow with a first 5G QoS identifier (5QI) and the second QoS flow with a second 5QI.

10. The method of claim 5, further comprising maintaining one of: the first audio channel on the first QoS flow, or the second audio channel on the second QoS flow, based at least in part on determining that the other one of the first audio channel or the second audio channel has degraded or dropped.

11. A method of wireless communication performed by a network entity, comprising:
determining that dual audio channels are to be established over dual quality of service (QoS) flows for a user equipment (UE); and
transmitting, to a base station, an instruction to establish a first audio channel of the dual audio channels over a first QoS flow for the UE and a second audio channel of the dual audio channels over a second QoS flow for the UE.

12. The method of claim 11, wherein the first QoS flow and the second QoS flow are associated with dual connectivity for the UE.

13. The method of claim 11, wherein the first QoS flow and the second QoS flow are associated with carrier aggregation for the UE.

14. A user equipment (UE) for wireless communication, comprising:
memory; and
one or more processors coupled to the memory, the memory comprising instructions executable by the one or more processors to cause the UE to:
receive an indication that dual audio channels are to be established over dual quality of service (QoS) flows; and
establish a first audio channel of the dual audio channels over a first QoS flow and a second audio channel of the dual audio channels over a second QoS flow based at least in part on receiving the indication.

15-23. (Canceled)

24. The UE of claim 14, wherein the first QoS flow and the second QoS flow are associated with dual connectivity for the UE.

25. The UE of claim 14, wherein the first QoS flow and the second QoS flow are associated with carrier aggregation for the UE.

26. The UE of claim 14, wherein the memory further comprises instructions executable by the one or more processors to cause the UE to maintain one of: the first audio channel on the first QoS flow, or the second audio channel on the second QoS flow, based at least in part on determining that the other one of the first audio channel or the second audio channel has degraded or dropped.
